(19) United States
(12) Patent Application Publication
(10) Pub. No.: US 2026/0292198 A1
(43) Pub. Date: Sep. 24, 2026

(54) DIRECTIONAL BOUNDARY CONTINUITY FOR VIDEO CODING

(71) Applicant: Tencent America LLC, Palo Alto, CA (US)

(72) Inventors: Lien-Fei CHEN, Palo Alto, CA (US); Roman CHERNYAK, Palo Alto, CA (US); Biao WANG, Palo Alto, CA (US); Yonguk YOON, Palo Alto, CA (US); Ziyue XIANG, Palo Alto, CA (US); Yifan WANG, Palo Alto, CA (US); Shan LIU, Palo Alto, CA (US)

(21) Appl. No.: 19/565,093

(22) Filed: Mar. 12, 2026

Related U.S. Application Data
(60) Provisional application No. 63/775,285, filed on Mar. 20, 2025.

(51) Int. Cl. H04N 19/139; H04N 19/105; H04N 19/159; H04N 19/176; H04N 19/80

(52) U.S. Cl. CPC H04N 19/139; H04N 19/105; H04N 19/159; H04N 19/176; H04N 19/80

(57) ABSTRACT

An example method of video decoding includes receiving a video bitstream comprising a plurality of blocks, including a current block. The method includes obtaining a reference block for the current block. The method includes obtaining a set of reference template samples for the reference block. The method includes determining a direction for the current block based on the set of reference template samples. The method further includes decoding the current block using the direction.

### RELATED APPLICATIONS

This application claims priority to U.S. Provisional Patent Application No. 63/775,285, entitled “Improvement of Directional Boundary Continuity for Video Coding,” filed Mar. 20, 2025, which is hereby incorporated by reference in its entirety.

### TECHNICAL FIELD

The disclosed embodiments relate generally to video coding, including but not limited to systems and methods for improving directional boundary continuity for video coding.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes various aspects of video coding, including methods and systems for improving directional boundary continuity for video coding. Boundary continuity in video coding refers to techniques designed to maintain visual smoothness and structural integrity across the boundaries of coding units (e.g., blocks), objects, or frames, reducing compression artifacts such as blocking or ringing. Conventional approaches determine boundary continuity by calculating gradients in only horizontal or vertical directions. The disclosed techniques improve directional boundary continuity by enabling gradient computations in diagonal directions (e.g., having both horizontal and vertical directional components) and deriving that direction from prediction-domain information. For example, a direction of the boundary continuity may be determined using a reference prediction sample and a reference template sample along a block boundary. The disclosed techniques provide flexibility in the boundary continuity direction determination process, reduce mismatch between the boundary continuity calculation and the true local structure, and improve overall coding performance and visual quality of decoded video.

In accordance with some embodiments, a method of video decoding includes (i) receiving a video bitstream comprising a plurality of blocks, including a current block; (ii) obtaining a reference block for the current block; (iii) obtaining a set of reference template samples for the reference block; (iv) determining a direction for the current block based on the set of reference template samples; and (v) decoding the current block using the direction.

In accordance with some embodiments, a method of video encoding includes (i) receiving video data comprising a plurality of blocks, including a current block; (ii) obtaining a reference block for the current block; (iii) obtaining a set of reference template samples for the reference block; (iv) determining a direction for the current block based on the set of reference template samples; and (v) encoding the current block using the direction.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates the computation of a prediction block in accordance with some embodiments.

FIG. 4B illustrates the computation of a residue block in accordance with some embodiments.

FIG. 4C illustrates the computation of a reconstructed block in accordance with some embodiments.

FIG. 5 illustrates the application of boundary continuity for predicting a sign of a transformed coefficient, in accordance with some embodiments.

FIG. 6 illustrates determining a direction for directional boundary continuity using reference prediction samples of a prediction block and reference template samples, in accordance with some embodiments.

FIG. 7A illustrates an example gradient-based direction determination at a given prediction sample along a block boundary of a coding block, in accordance with some embodiments.

FIG. 7B illustrates an example gradient-based direction determination that is implemented using a Sobel filter, in accordance with some embodiments

FIG. 8A illustrates an example video decoding process in accordance with some embodiments.

FIG. 8B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes, amongst others, methods and systems for improving directional boundary continuity for video coding. Boundary continuity at video coding block edges is important because block-based prediction and transform coding inherently create artificial discontinuities at block boundaries, and many video coding decisions depend on how well the reconstructed signal aligns across those boundaries. In accordance with some embodiments, a computing system receives a video bitstream comprising a plurality of blocks, including a current block. The computing system obtains a reference block for the current block. The computing system obtains a set of reference template samples for the reference block. The computing system determines a direction for the current block based on the set of reference template samples, and decodes the current block using the direction. The disclosed methods for determining a direction of boundary continuity can reduce mismatch between the boundary continuity calculation and the true local structure, reduce visual artifacts, and improve overall coding performance and visual quality of decoded video.

### Example Systems and Devices

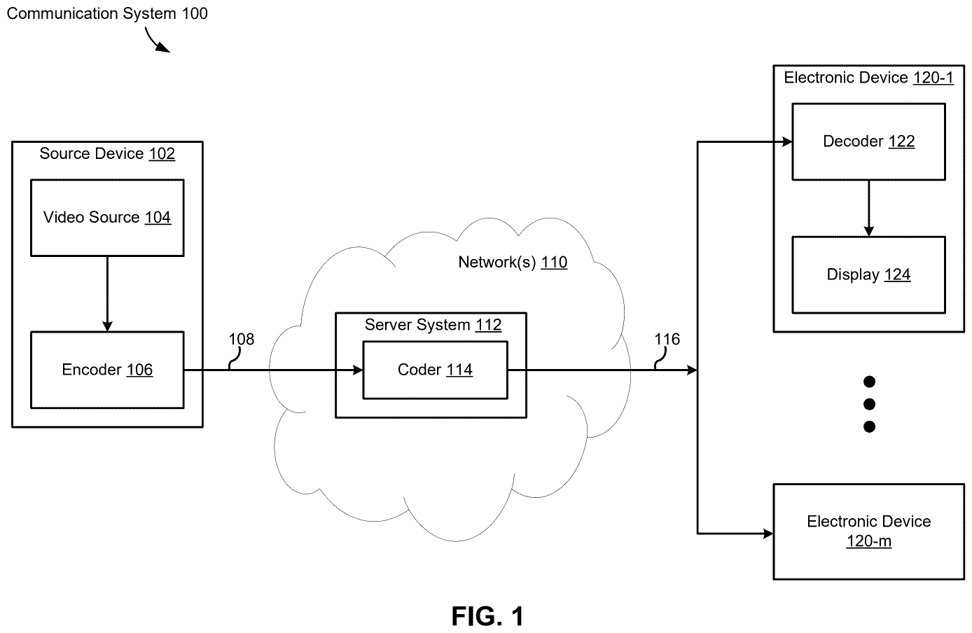

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

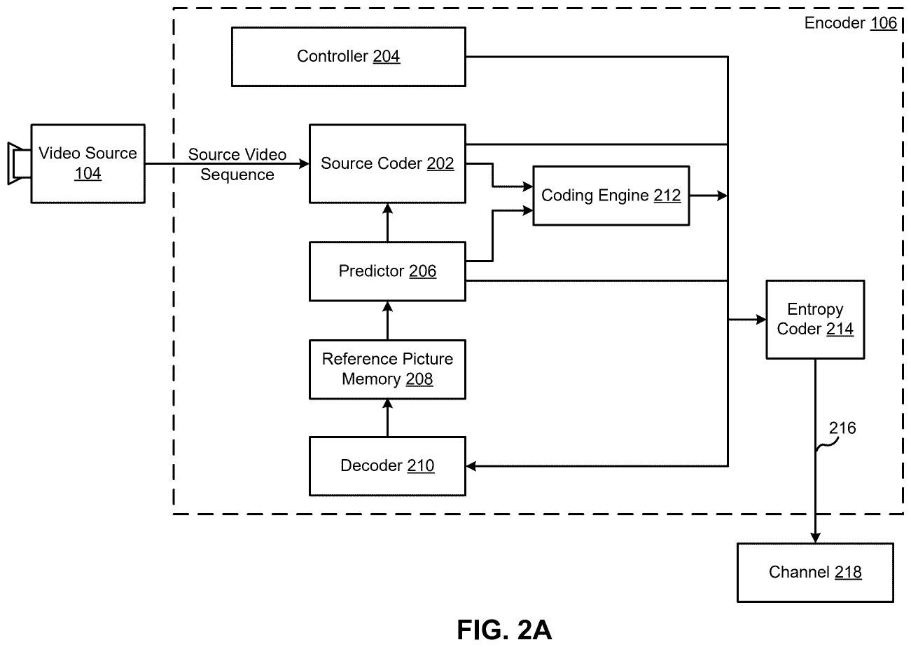

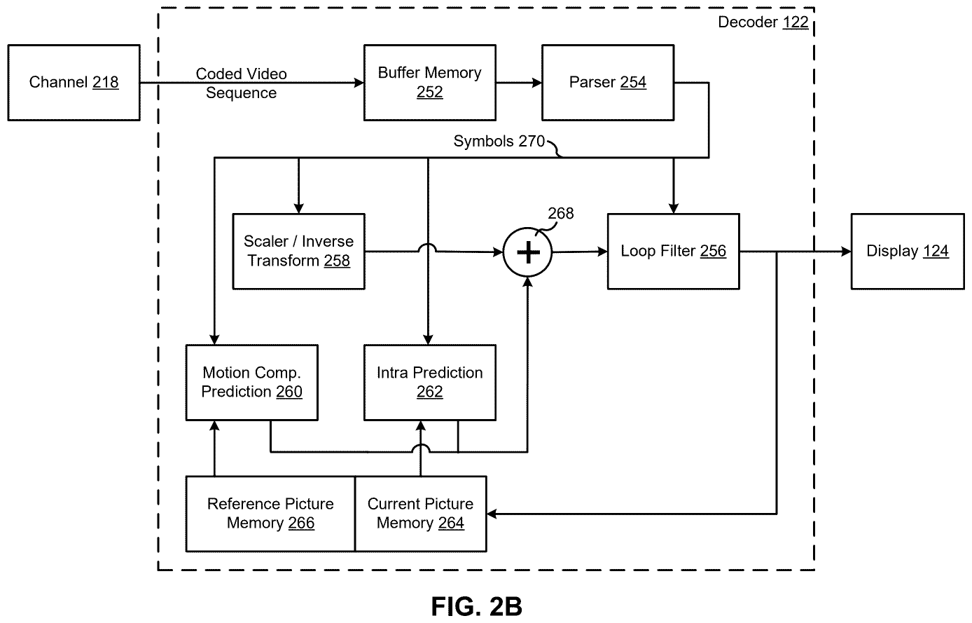

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

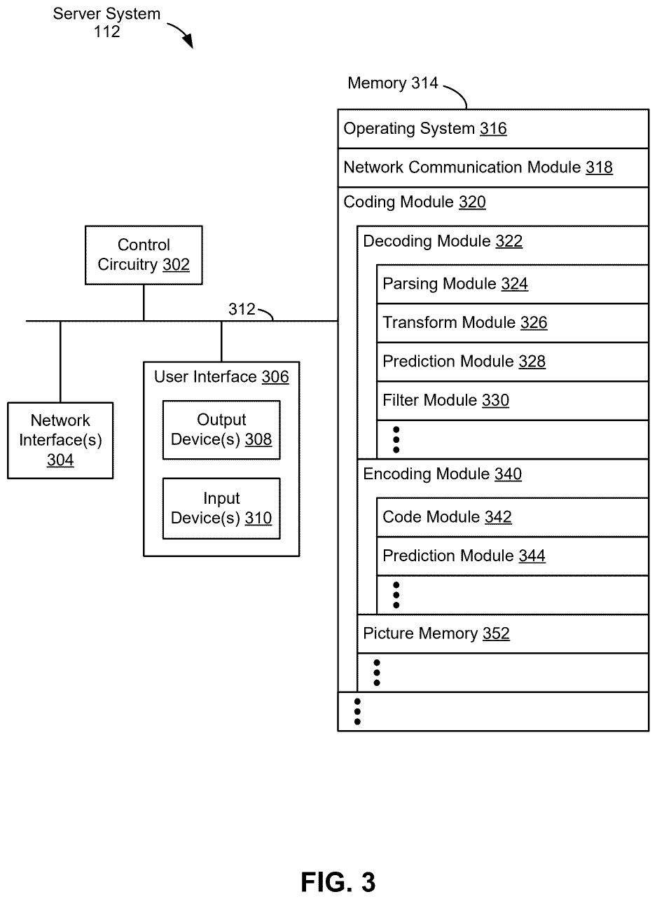

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, methods for determining directional boundary continuity are described.

Video coding has been widely used in many applications such as broadcasting, video recording, and video streaming. Video coding standards include H.264, H.265/HEVC, H.266/VVC, and AV1, and are widely adopted in these video applications. In general, a hybrid video codec includes the following coding modules: intra prediction, inter prediction, transform coding, quantization, entropy coding, and post in-loop filter, which are described above with reference to FIGS. 1 to 3.

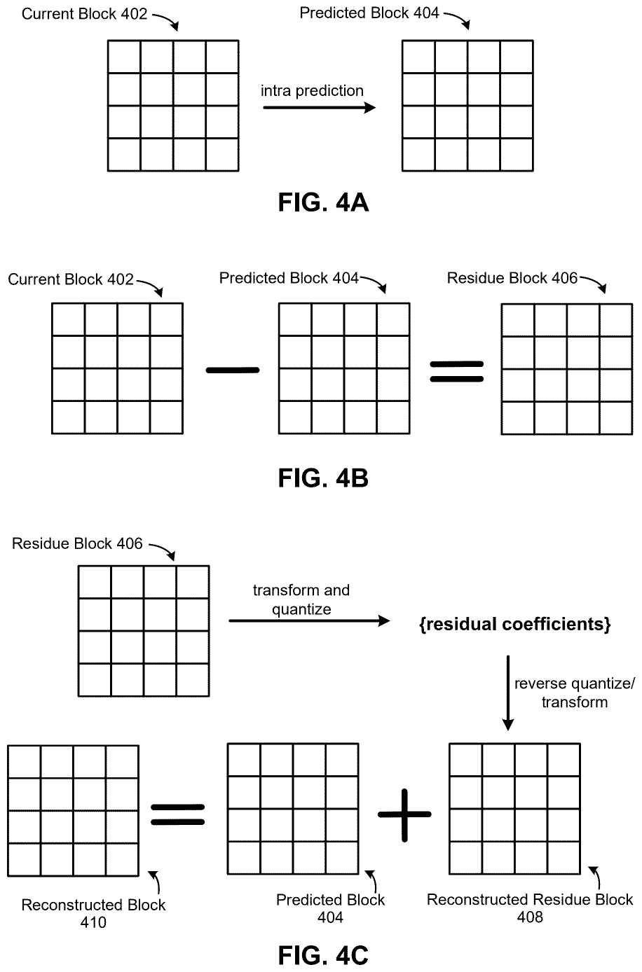

To this end, FIGS. 4A-4C illustrate an overview of a quantization and subsequent dequantization process. FIG. 4A illustrates the computation of a prediction block in accordance with some embodiments. In the example of FIG. 4A, an intra prediction is performed on a current block 402 to generate a predicted block 404. The current block 402 includes a set of samples (e.g., pixel blocks) and the prediction block 404 includes a set of predictions that correspond to the set of samples. FIG. 4B illustrates the computation of a residue block in accordance with some embodiments. As shown in FIG. 4B, the prediction block 404 is subtracted from the current block 402 to generate a residue block 406 that includes a set of residues. For example, respective differences are calculated between each sample and the corresponding prediction. FIG. 4C illustrates the computation of a reconstructed block in accordance with some embodiments. As shown in FIG. 4C, the residue block 406 undergoes one or more transformations and quantization to generate a set of residual coefficients. The set of residual coefficients may be transmitted from an encoder component to a decoder component. The set of residual coefficients undergo a reverse quantization and reverse transformation to generate a reconstructed residue block 408. The reconstructed residue block 408 is combined with the predicted block 404 (e.g., reconstructed residues of the reconstructed residue block 408 are added to predictions of the prediction block 404) to generate a reconstructed block 410 corresponding to the current block 402.

Notably, the transforms performed during decoding of the video bitstream may be inverses of the transformed performed during encoding of the video bitstream, and are sometimes referred to as “inverse transforms”. For simplicity, the transformations described herein may be referred to as “transforms” whether performed during encoding or decoding.

Turing now to boundary continuity, boundary continuity may be used in video coding to facilitate prediction-related determinations based on relationships between samples of a current block and spatially neighboring samples located along a boundary of the current block. In some embodiments, boundary continuity is evaluated by generating candidate predicted samples for a current block and comparing the candidate predicted samples to one or more neighboring samples adjacent to the boundary of the current block. In accordance with some embodiments, for samples along a boundary of a current block, the video encoder and/or decoder generates or accesses a reference prediction sample generated using a motion vector (BV) and/or a block vector (BV) and a corresponding reference template sample from adjacent neighbor samples along a boundary of the referenced prediction block. A gradient is computed for a plurality of candidate directions. In some embodiments, the gradient is computed using a Sobel operator or other gradient filter, and a direction associated with a smallest gradient is selected. The selected direction is then used to perform the directional boundary continuity calculation (e.g., for decisions such as residual/coefficient hypothesis evaluation) for the corresponding boundary samples of the current block.

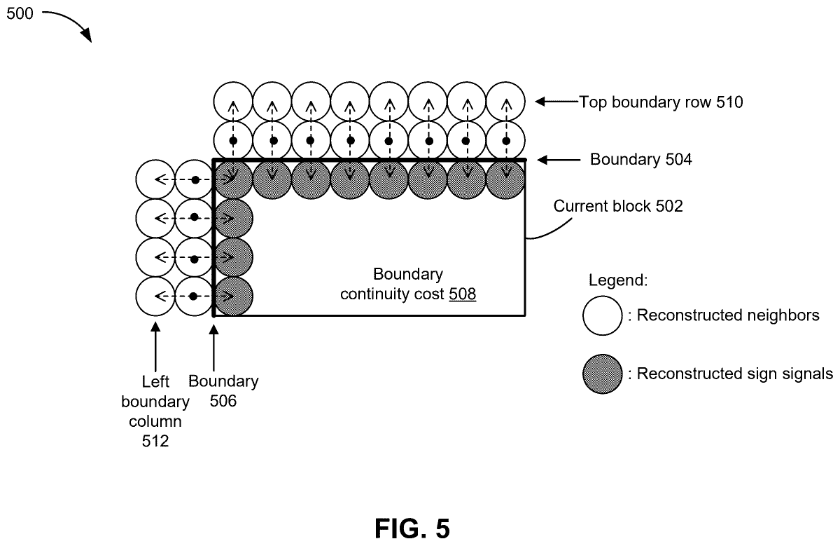

FIG. 5 shows an example block diagram 500 illustrating the application of boundary continuity for predicting a sign of a transformed coefficient, in accordance with some embodiments. Sign prediction may be applied to improve the sign coding efficiency for the non-zero transform coefficients, by predicting the signs of non-zero transform coefficients in one transform block (TB) using its neighboring reconstructed samples. To predict the signs, a continuity measurement across the block boundary is defined as a cost function, which is defined as a sum of absolute second derivatives in the residual domain for the above row and left column, as shown in Equation 1 below:

$$cost = {\sum }_{x = o}^{w} \vert ( - {R}_{x , - 1} + 2 {R}_{x , 0} - {P}_{x , 1} ) - {r}_{x , 1} \vert + {\sum }_{y = o}^{h} \vert ( - {R}_{- 1 , y} + 2 {R}_{0 , y} - {P}_{1 , y} ) - {r}_{1 , y} \vert \qquad Equation 1$$

In Equation 1, R refers to reconstructed neighbors, P is a prediction of the current block, and r is the residual hypothesis. The term (−R₋₁+2R₀−P₁) can be calculated only once per block and only the residual hypothesis is subtracted.

The example of FIG. 5 shows a current block 502 having a first boundary 504 (e.g., top edge of the current block 502) and a second boundary 506 (e.g., a left edge of the current block 502). A boundary continuity cost 508 based on second-derivative-like terms can be computed along a top boundary row 510 and a left boundary column 512 of the current block 502, using reconstructed neighbor samples.

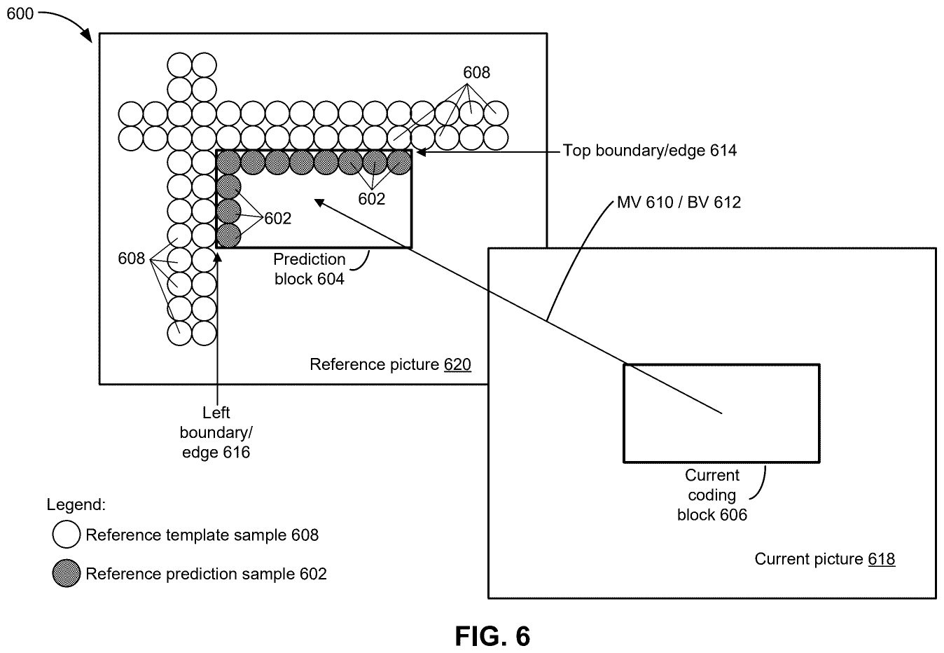

FIG. 6 is a block diagram 600 illustrating determination of a direction for directional boundary continuity using (i) reference prediction samples 602 of a prediction block 604 associated with a current coding block 606 (e.g., current block) and (ii) reference template samples 608 that are adjacent neighbors along one or more boundaries (e.g., top boundary/edge 614 and left boundary/edge 616) of the prediction block 604, in accordance with some embodiments. The current coding block is part of a current picture 618 and the prediction block 604 is part of a reference picture 620. In some embodiments, the current coding block 606 includes a motion vector (MV) 610 that points to the prediction block 604. In some embodiments, the current coding block 606 includes a derived or signaled block vector (BV) 612 that points to the prediction block 604. The reference prediction samples 602 are predicted using at least the MV 610 and/or BV 612 and the reference template samples 608, which are the adjacent neighbors along the one or more boundaries (e.g., boundary 614 and boundary 616) of the prediction block 604.

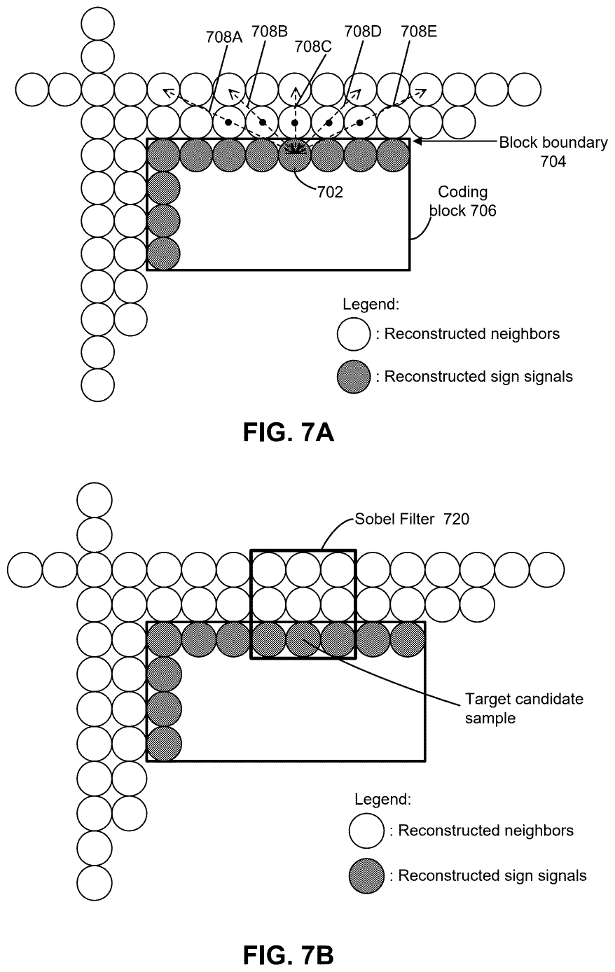

FIG. 7A illustrates an example gradient-based direction determination at a given prediction sample 702 along a block boundary 704 of a coding block 706, in accordance with some embodiments. For the prediction sample 702, gradients are computed for multiple candidate directions (e.g., directions 708A, 708B, 708C, 708D, and 708E) by comparing the prediction sample 702 to corresponding neighboring template samples in those directions. In some embodiments, the gradient calculation calculates the difference between a prediction sample and the corresponding neighboring sample from different directions, and then the direction with the smallest gradient value is selected as the direction used for the directional boundary continuity calculation at that sample. Each prediction sample along the block boundary may determine its associated direction for the boundary continuity using this approach. The derived direction for boundary continuity at each sample may then be used for the corresponding reconstructed candidate sample along the block boundary within the current coding block. In some embodiments, the derived directions are the same as defined angular intra prediction directions (e.g., 65 angular intra prediction directions). In some embodiments, directions for the top boundary are restricted to directions between certain intra prediction modes (e.g., between intra prediction mode 34 and intra prediction mode 66), and directions for the left boundary may be restricted to directions between other intra prediction modes (e.g., between intra prediction mode 2 and intra prediction mode 34). In some embodiments, a Histogram of Gradient (HoG) method is used for deriving the directions.

FIG. 7B illustrates an example gradient-based direction determination that is implemented using a Sobel filter 720, in accordance with some embodiments. The Sobel filter 720 may be applied to determine the gradient direction for a target candidate sample based on surrounding sample values. In some embodiments, when calculating a Sobel filter output, the direction with the strongest edge is identified and used for the directional boundary continuity calculation. In some embodiments, overlapped template regions (e.g., 8×2 or 2×8 template regions) with reconstructed samples are used for deriving the directions for the top and left sub-boundaries. In some embodiments, the directions are derived for sub-boundaries (e.g., every 4-sample sub-boundaries) on the top row and left column of the coding block.

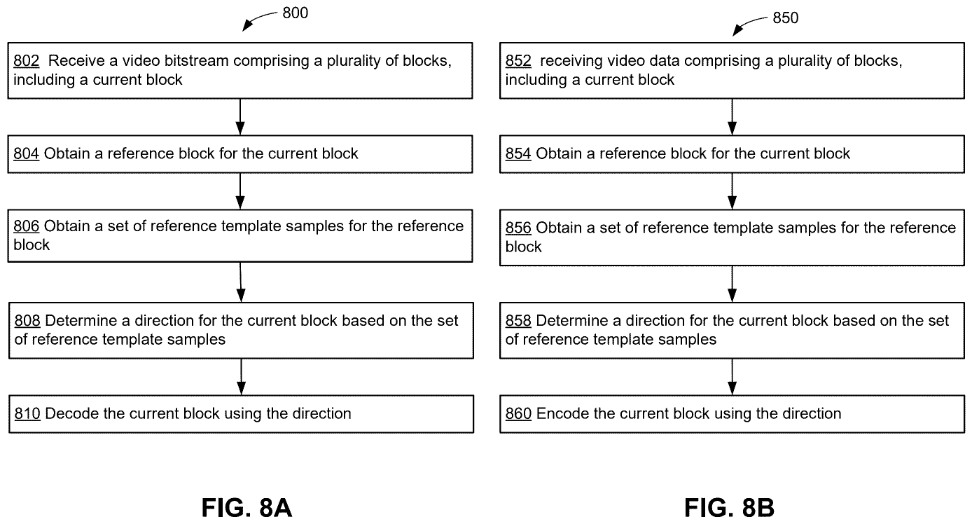

FIG. 8A is a flow diagram illustrating a method 800 of decoding video in accordance with some embodiments. The method 800 may be performed at a computing system (e.g., the server system 112, the source device 102, or the electronic device 120) having control circuitry and memory storing instructions for execution by the control circuitry. In some embodiments, the method 800 is performed by executing instructions stored in the memory (e.g., the memory 314) of the computing system.

The computing system receives (802) a video bitstream comprising a plurality of blocks. The plurality of blocks includes a current block. The computing system obtains (804) a reference block for the current block. The computing system obtains (806) a set of reference template samples for the reference block. The computing system determines (808) a direction for the current block based on the set of reference template samples. The computing system decodes (810) the current block using the direction.

In some embodiments, the direction of the directional boundary continuity of a coding block may be determined by using the reference prediction sample (e.g., reference prediction sample 602) and the reference template sample (e.g., reference template sample 608) along the block boundary (e.g., boundary 614). The reference prediction sample is predicted by using at least one given motion vector (MV) (e.g., MV 610) and/or block vector (BV) (e.g., BV 512) and the reference template sample is the adjacent neighbors along the boundary of the prediction block. FIG. 6 shows an example of sample usage for the determination of the direction for the directional boundary continuity in accordance with some embodiments.

In some embodiments, the current block (e.g., current coding block 606) is coded in inter prediction mode. In some embodiments, the determination of the directional boundary continuity is implicitly disabled on the inter coding block when intra prediction samples are used for the inter coding block. For example, the determination of the directional boundary continuity is disabled when the coding block is predicted using a combination of inter prediction and intra prediction samples, or when the coding block is predicted using geometric partition block with inter and intra prediction samples.

In some embodiments, the direction of the directional boundary continuity is applied on the coding block and the associated prediction block of the coding block is predicted from the reconstructed region of the coding picture.

In some embodiments, the derived or signaled BV(s) of the coding block point to the associated prediction block(s), as illustrated in FIG. 6. In this case, the coding block is usually coded in intra block copy mode or intra template-matching prediction mode.

In some embodiments, the current block can be but is not limited to a coding unit, a prediction unit, or a transform unit.

In some embodiments, the reference template sample can be generated by using interpolation filter when the pointed MV/BV has fractional precision. In some embodiments, the interpolation filter used for template is identical to the interpolation filter used for prediction block generation. In some embodiments, the interpolation filter for template can be any kind of interpolation filter, such as bilinear filter, 8-tap or a DCT interpolation filter.

In some embodiments, the reference prediction block and the reference template are both the weighted average of the prediction block and the associated template from the corresponding reference picture. For example, the reference prediction block is the weighted average of the prediction block from reference list 0 and reference list 1; the reference template is the weighted average of the template of the prediction block from reference list 0 and the template of the prediction block from reference list 1 as well.

In some embodiments, the gradient calculation calculates the difference between a prediction sample and the corresponding neighboring sample from different directions, and then the direction with the smallest gradient value is selected as the direction for the directional boundary continuity calculation at that prediction sample. FIG. 7A shows an example of gradient calculation for the determination of direction at a given prediction sample along the coding block boundary, in accordance with some embodiments. Each prediction sample along the block boundary can determine its associated direction for the boundary continuity by using the example as shown in FIG. 7A. Finally, the derived direction for boundary continuity at each sampling is used for the corresponding reconstructed candidate sample along the block boundary within the current coding block.

In some embodiments, a template width for the above boundary continuity and the template height for the left boundary continuity should be larger than or equal to the current block width and the current block height respectively. In some embodiments, the gradient calculation described above is applied on N prediction samples to determine the direction for these N prediction sample, where Nis a positive integer number which is larger than 1. In some embodiments, the value of N can be different according to different block sizes and/or block shapes. In some embodiments, the gradient calculation can be performed by applying a Sobel filter. One example of using the Sobel filter for gradient calculation is shown in FIG. 7B.

FIG. 8B is a flow diagram illustrating a method 850 of encoding video in accordance with some embodiments. The method 850 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 850 is performed by a same system as the method 800 described above.

The system receives (852) video data comprising a plurality of blocks, including a current block. The system obtains (854) a reference block for the current block. The system obtains (856) a set of reference template samples for the reference block. The system determines (858) a direction for the current block based on the set of reference template samples. The system encodes (860) the current block using the direction.

As described previously, the encoding process may mirror the decoding processes described herein (e.g., directional boundary determination). For brevity, those details are not repeated here.

Although FIGS. 8A and 8B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.
(A1) In one aspect, some embodiments include a method (e.g., the method 800) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks, including a current block; (ii) obtaining a reference block for the current block; (iii) obtaining a set of reference template samples for the reference block; (iv) determining a direction for the current block based on the set of reference template samples; and (v) decoding the current block using the direction. In this way, the direction of the directional boundary continuity may be determined by using a reference prediction sample and a reference template sample along a block boundary. The reference prediction sample may be predicted by using a MV and/or BV and the reference template sample is the adjacent neighbors along the boundary of the prediction block. In some embodiments, the reference block is a prediction block in a reference frame for the current block. In some embodiments, the direction is a gradient direction or a texture direction. In some embodiments, the set of reference template samples comprises two or more samples. In some embodiments, a sign for a transform coefficient of the current block is determined using the direction. In some embodiments, decoding the current block using the direction comprises determining a transform coefficient sign for the current block based on the direction.
(A2) In some embodiments of A1, the direction corresponds to a smallest gradient value between a sample of the reference block and the set of reference template samples. For example, the gradient calculation calculates the difference between a prediction sample and the corresponding neighboring sample from different directions, and then the direction with the smallest gradient value is selected as the direction for the directional boundary continuity calculation at that prediction sample. Each prediction sample along the block boundary can determine its associated direction for the boundary continuity. The derived direction for boundary continuity at each sample is then used for the corresponding reconstructed candidate sample along the block boundary within the current coding block.
(A3) In some embodiments of A1 or A2, the direction is determined by applying a Sobel filter to the set of reference template samples. For example, the gradient calculation may comprise using a Sobel filter. In some embodiments, the gradient calculation is applied on N prediction samples to determine the direction for these N prediction samples, where Nis a positive integer number greater than 1. The value of N can be different according to different block sizes and/or block shapes. In some embodiments, when calculating a Sobel filter output, the direction with the strongest edge is identified and used for the directional boundary continuity calculation.
(A4) In some embodiments of any of A1-A3, the current block is an inter-predicted block. For example, the direction is determined for a coding block that is coded in inter prediction mode. In some embodiments, the direction is used to apply the inter prediction (e.g., is applied when determining an MV for the prediction). In some embodiments, the direction for the current block is determined when the current block is inter predicted (and is not determined when the current block is intra predicted). For inter-coded blocks, the texture direction can be determined based on the reference block because there is coherence and correlation between the current block and the reference block. Texture features can be inherited from the reference picture, and the direction determination leverages the similarity between the current block and its reference block.
(A5) In some embodiments of any of A1-A4, the direction is determined when the current block is inter predicted without using intra prediction samples. For example, the direction determination is implicitly disabled on the inter coding block when intra prediction samples is used for this inter coding block. For example, the determination of the directional boundary continuity is disabled when the coding block is predicted using a combination of inter prediction and intra prediction samples, or when the coding block is predicted using geometric partition block with inter and intra prediction samples. In some embodiments, the current block uses geometric partition mode (GPM), where the current block is split into two different partitions and one partition is predicted from inter prediction while another partition is predicted from intra prediction. When intra prediction is used, the intra prediction mode already indicates the direction, so deriving the direction from reference samples is not needed.
(A6) In some embodiments of any of A1-A5, the reference block comprises a predicted reference block from a reconstructed region of a current frame. For example, the direction determination is applied for the coding block and the associated prediction block of the coding block is predicted from the reconstructed region of the coding picture. In some embodiments, the current block and the reference block are in a same frame. In some embodiments, the current block and the reference block are in different frames of the video data. The reference block can be found from a previously coded region of the current picture because similar data can often be found in natural images within the same frame.
(A7) In some embodiments of A6, the reference block is identified by applying a block vector to the current block. For example, derived or signaled BV(s) of the coding block point to the associated prediction block(s). In this case, the coding block is usually coded in intra block copy mode or intra template-matching prediction mode. In some embodiments, the current block is encoded using an intra block copy (IBC) mode. In some embodiments, the current block is encoded using a template-matching mode. The block vector can be derived implicitly or signaled explicitly in the bitstream. Other prediction modes that use block vectors pointing to reconstructed regions of the current picture may also be used.
(A8) In some embodiments of any of A1-A7, the current block comprises a transform block. For example, the current block can be a coding unit, prediction unit, transform unit, etc. In some embodiments, the current block is a prediction block. In some embodiments, the current block is a coding block. Sign prediction is a transform domain coding tool, so the method can be applied on the transform unit. In some embodiments, the directional sign prediction is applied to luma transform blocks where more than 1 sign is predicted.
(A9) In some embodiments of any of A1-A8, the set of reference template samples are obtained using an interpolation filter. For example, a reference template sample can be generated by using interpolation filter when the pointed MV/BV has fractional precision. In some embodiments, the current block has a corresponding fractional MV or BV. In some embodiments, the interpolation filter is a multi-tap filter. In some embodiments, the interpolation filter is a multi-tap filter. For example, the interpolation filter for template may be any kind of interpolation filter, such as bilinear filter, 4-tap filter, 8-tap DCT interpolation filter, etc. In some embodiments, 4-tap interpolation filters are used for generating the reconstructed samples at fractional positions.
(A10) In some embodiments of A9, the interpolation filter is also used for prediction block generation. For example, the interpolation filter used for template is identical to the interpolation filter used for prediction block generation. In some embodiments, the reference block is a prediction block obtained using the interpolation filter. Using the same interpolation filter for both template and prediction block generation ensures consistency between the template samples and the prediction samples.
(A11) In some embodiments of any of A1-A10, the reference block is obtained by performing a weighted average of multiple reference blocks. In some embodiments, the reference template samples are obtained by performing a weighted average of multiple reference templates. For example, the reference prediction block and the reference template may both be the weighted average of the prediction block and the associated template from the corresponding reference picture. As an example, the reference prediction block is the weighted average of the prediction block from reference list 0 and reference list 1 and the reference template is the weighted average of the template of the prediction block from reference list 0 and the template of the prediction block from reference list 1 as well. In some embodiments, bi-prediction weighted coding (BCW) is used, where different weights (e.g., ratios such as 3:5 rather than half and half) are applied to the prediction blocks from the two reference lists. If the coding block is coded in bi-prediction, the same weighting condition is applied on the template to generate the final reference template.
(A12) In some embodiments of any of A1-A11, the direction is determined by calculating respective differences between a sample of the reference block and the set of reference template samples. For example, the gradient calculation calculates the difference between a prediction sample and the corresponding neighboring sample from different directions, and then the direction with the smallest gradient value is selected as the direction for the directional boundary continuity calculation at that prediction sample. The direction with the smallest gradient value indicates the direction along which the sample values change least, suggesting alignment with the local texture or edge orientation.
(A13) In some embodiments of any of A1-A12, the set of reference template samples correspond to a template area for the reference block, and wherein the template area has a dimension that is greater than a corresponding dimension of the current block. For example, a template width for the above boundary continuity and the template height for the left boundary continuity may be larger than or equal to the current block width and the current block height respectively. In some embodiments, overlapped template regions (e.g., 8×2 or 2×8 template regions) with reconstructed samples are used for deriving the directions for the top and left sub-boundaries.
(A14) In some embodiments of A13, respective directions are determined for a plurality of samples in the reference block. For example, a gradient calculation (as described previously) is applied on N prediction sample to determine the direction for these N prediction sample, where N is a positive integer number which is larger than 1. In some embodiments, the directions are derived for every 4-sample sub-boundaries on the top row and left column. In some embodiments, the derived directions are identical to the defined 65 angular intra prediction directions.
(A15) In some embodiments of A14, a number of the plurality of samples is based on at least one of a block size of the current block, and a block shape of the current block. For example, the number of prediction samples for gradient calculation can be different according to different block size and/or block shape. As an example, larger blocks have more sub-boundaries and thus more direction determinations, while smaller blocks have fewer sub-boundaries.
(B1) In another aspect, some embodiments include a method (e.g., the method 850) of video encoding. In some embodiments, the method is performed at a computing system (e.g., the server system 112) having memory and control circuitry. In some embodiments, the method is performed at a coding module (e.g., the coding module 320). The method includes: (i) receiving video data comprising a plurality of blocks, including a current block; (ii) obtaining a reference block for the current block; (iii) obtaining a set of reference template samples for the reference block; (iv) determining a direction for the current block based on the set of reference template samples; and (v) encoding the current block using the direction
(B2) In some embodiments of B1, the direction corresponds to a smallest gradient value between a sample of the reference block and the set of reference template samples. For example, the gradient calculation calculates the difference between a prediction sample and the corresponding neighboring sample from different directions, and then the direction with the smallest gradient value is selected as the direction for the directional boundary continuity calculation at that prediction sample. Each prediction sample along the block boundary can determine its associated direction for the boundary continuity. The derived direction for boundary continuity at each sample is then used for the corresponding reconstructed candidate sample along the block boundary within the current coding block.
(B3) In some embodiments of B1 or B2, the direction is determined by applying a Sobel filter to the set of reference template samples. For example, the gradient calculation may comprise using a Sobel filter. In some embodiments, the gradient calculation is applied on N prediction samples to determine the direction for these N prediction samples, where N is a positive integer number greater than 1. The value of N can be different according to different block sizes and/or block shapes. In some embodiments, when calculating a Sobel filter output, the direction with the strongest edge is identified and used for the directional boundary continuity calculation.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A15 and B1-B3 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A15 and B1-B3 above). In some embodiments, a memory or non-transitory computer-readable storage medium stores a video bitstream including any of the features (e.g., syntax and encoded information) disclosed herein.

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block;
obtaining a reference block for the current block;
obtaining a set of reference template samples for the reference block;
determining a direction for the current block based on the set of reference template samples; and
decoding the current block using the direction.

2. The method of claim 1, wherein the direction corresponds to a smallest gradient value between a sample of the reference block and the set of reference template samples.

3. The method of claim 1, wherein the direction is determined by applying a Sobel filter to the set of reference template samples.

4. The method of claim 1, wherein the current block is an inter-predicted block.

5. The method of claim 1, wherein the direction is determined when the current block is inter predicted without using intra prediction samples.

6. The method of claim 1, wherein the reference block comprises a predicted reference block from a reconstructed region of a current frame.

7. The method of claim 6, wherein the reference block is identified by applying a block vector to the current block.

8. The method of claim 1, wherein the current block comprises a transform block.

9. The method of claim 1, wherein the set of reference template samples are obtained using an interpolation filter.

10. The method of claim 9, wherein the interpolation filter is also used for prediction block generation.

11. The method of claim 1, wherein the reference block is obtained by performing a weighted average of multiple reference blocks.

12. The method of claim 1, wherein the direction is determined by calculating respective differences between a sample of the reference block and the set of reference template samples.

13. The method of claim 1, wherein the set of reference template samples correspond to a template area for the reference block, and wherein the template area has a dimension that is greater than a corresponding dimension of the current block.

14. The method of claim 1, wherein respective directions are determined for a plurality of samples in the reference block.

15. The method of claim 14, wherein a number of the plurality of samples is based on at least one of a block size of the current block, and a block shape of the current block.

16. A method of video encoding performed at a computing system having memory and one or more processors, the method comprising:
receiving video data comprising a plurality of blocks, including a current block;
obtaining a reference block for the current block;
obtaining a set of reference template samples for the reference block;
determining a direction for the current block based on the set of reference template samples; and
encoding the current block using the direction.

17. The method of claim 16, wherein the direction corresponds to a smallest gradient value between a sample of the reference block and the set of reference template samples.

18. The method of claim 16, wherein the direction is determined by applying a Sobel filter to the set of reference template samples.

19. A non-transitory computer-readable storage medium storing a video bitstream that is generated by a video encoding method, the video bitstream comprising:
coded information for a plurality of blocks, including a current block; and
wherein the video encoding method comprises:
obtaining a reference block for the current block;
obtaining a set of reference template samples for the reference block;
determining a direction for the current block based on the set of reference template samples; and
encoding the current block using the direction.

20. The non-transitory computer-readable storage medium of claim 19, wherein the video bitstream further comprises an indicator that indicates a motion vector or block vector for the current block.
